(19) United States
(12) Patent Application Publication
(10) Pub. No.: US 2009/0121189 A1
(43) Pub. Date: May 14, 2009

(54) SYNTHESIS OF BIO-FUNCTIONALIZED RARE EARTH DOPED UPCONVERTING NANOPHOSPHORS

(75) Inventors: Yiguang Ju, Pennington, NJ (US); Jingning Shan, Princeton, NJ (US)

Correspondence Address: FOX ROTHSCHILD LLP;PRINCETON PIKE CORPORATE CENTER, 2000 Market Street, Tenth Floor, Philadelphia, PA, 19103, US

(73) Assignee: THE TRUSTEES OF PRINCETON UNIVERSITY, Princeton, NJ (US)

(21) Appl. No.: 12/246,163

(22) Filed: Oct. 6, 2008

Related U.S. Application Data
(60) Provisional application No. 60/977,633, filed on Oct. 4, 2007.

(51) Int. Cl. C09K 11/77; C09K 11/00

(52) U.S. Cl. 252/301.6 R; 252/301.4 R

(57) ABSTRACT

Methods for preparing rare earth doped monodisperse, hexagonal phase upconverting nanophosphors, the steps of which include:
dissolving one or more rare earth precursor compounds and one or more host metal fluoride compounds in a solvent containing a tri-substituted phosphine or a tri-substituted phosphine oxide to form a solution;
heating the solution to a temperature above about 250° C. at which the phosphine or phosphine oxide remains liquid and does not decompose; and
precipitating and isolating from the solution phosphorescent hexagonal phase monodisperse nanoparticles of the host metal compound doped with rare earth elements.
   Nanoparticles according to the present invention, and methods for coating the nanoparticles with SiO₂ are also disclosed.

### CROSS-REFERENCE TO RELATED APPLICATIONS

This application claims priority under 35 U.S.C. §119(e) to U.S. Provisional Patent Application Nos. 60/977,633 and 61/320,003 filed Oct. 4, 2007 and Feb. 2, 2008, respectively. The disclosures of both applications are incorporated herein by reference in their entirety.

### FIELD OF THE INVENTION

This invention relates to low temperature methods for producing essentially pure hexagonal phase upconverting fluoride nanophosphors doped with rare earth elements.

### BACKGROUND OF THE INVENTION

In recent years nanoparticle technology has become a research focus as its fundamental and practical importance becomes more widely known, especially in the case of luminescent materials. For example, upconverting nanophosphors, such as rare earth doped phosphorescent oxide salt particles, exhibit unique chemical and physical properties when compared with their bulk materials, their properties being halfway between molecular and bulk solid state structures. An example would be quantum confinement effects, which brings electrons to higher energy levels, leading to novel optoelectronic properties. Nanoparticles are also finding use in optical, electrical, biological, chemical, medical and mechanical applications and can be found in television sets, computer screens, fluorescent lamps, lasers, etc.

Various methods such as, thermal hydrolysis, laser heat evaporation, chemical vapor synthesis, microemulsion spray pyrolysis, and pool flame synthesis have been used to prepare “nano-sized” oxide salt particles or phosphors. However, these methods generally require either high temperatures, long processing times, repeated milling, the addition of flux, or washing with chemicals, to obtain the desired multi-component oxide particle.

Low temperature methods, such as sol-gel and homogenous precipitation, have also been used to synthesize upconverting nanophosphors. However upconverting nanophosphors synthesized using sol-gel techniques have low crystallinity and require post-treatment or annealing at high temperature to crystallize. In low temperature synthesis, an annealing step at a temperature of from about 900 to about 1300° C. for about six hours or more is required to achieve uniform ion incorporation and increase efficiency. The annealing step, as well as the afore-mentioned high temperature processes, can increase particle size through agglomeration and also result in contamination.

In addition, low temperature processes for producing nanophosphors, especially rare earth doped fluoride nanophosphors, tend to lead to non-uniform ion incorporation, resulting in low quenching limit concentrations, at best between about 5 mol % and about 7 mol %. The non-uniform ion incorporation produces variations in the distance between dopant ions, with some ions so close that ion-ion interactions produce quantum quenching. This increases as ion concentration increases until a concentration is reached above which decreased fluorescence results. This is defined as the quenching limit concentration.

Furthermore, because upconverting fluoride nanophosphors are hydrophobic, they need to be modified to be hydrophilic to be useful for biological applications. However, due to the strong negative ion properties of the upconverting nanophosphors hosts, the conversion of hydrophobic upconverting fluoride nanophosphors to hydrophilic ones without particle agglomeration remains challenging.

Therefore, there is still a need in the art for a process for producing upconverting fluoride nanophosphors with more uniform ion incorporation having higher quenching limit concentrations, as well as for a process for modifying upconverting fluoride nanophosphors for biological applications to reduce hydrophobicity without causing particle agglomeration.

### SUMMARY

The present invention addresses these needs by providing processes for producing fluoride nanoparticles with more uniform ion incorporation having higher quenching limit concentrations. The inventive methods make possible the low-temperature preparation of activated hydrophilic hexagonal phase rare earth doped fluoride particles on a nano-scale with uniform spherical size. Furthermore, the inventive methods are also effective over a wide reaction temperature window.

In one aspect, methods of preparing rare earth doped monodisperse, hexagonal phase fluoride upconverting nanophosphors (UCNPs) are provided. The methods dissolve one or more rare earth element dopant precursor compounds and one or more host metal fluoride compounds in a solvent comprising a tri-substituted phosphine or tri-substituted phosphine oxide to form a solution; heating the solution to a temperature above 250° C. at which the phosphine or phosphine oxide remains liquid and does not decompose; and precipitating and isolating from the solution hexagonal phase monodisperese nanophosphors of the host metal fluoride host doped with one or more rare earth elements.

According to one embodiment, the rare earth precursor compound is an organometallic rare earth complex having the structure:

RE(X)₃

wherein RE is a rare earth element and X is an organic ligand. According to another embodiment, X is a trifluoroacetate ligand. According to another embodiment, RE is yttrium, holmium, ytterbium, erbium or thulium.

According to one embodiment host metal compounds are selected so the resulting hosts are in the form of fluorides or oxyfluorides of host metals.

According to one embodiment, the solution contains a phosphine oxide. According to another embodiment the phosphine oxide is trioctylphosphine oxide (TOPO) and the temperature is between about 250° C. and about 400° C. According to another embodiment, the temperature is between about 315° C. and about 370° C. According to another embodiment, the solution is heated to temperature over a period of about 10 to about 15 minutes.

According to one embodiment, the nanophosphors are precipitated by the addition of a polar solvent with cooling. According to another embodiment, the polar solvent is an alcohol.

In another aspect, hexagonal phase mono-disperse fluoride nanophosphors of a host metal compound doped with one or more rare earth elements are provided, which have been prepared by the method of the present invention. According to one embodiment, the particles provided by the inventive method have a monodisperse particle size between about 5 and about 200 nm. According to another embodiment, the particles provided by the inventive method have a monodisperse particle size less than about 20 nm, such as between about 5 and about 20 nm, between about 5 and about 15 nanometers, between about 5 and about 10 nanometers, or between about 10 and about 15 nanometers. According to another embodiment, the nanoparticles have a quantum quenching concentration above about 10 mol %.

In another aspect, methods for coating fluoride up-converting nanophosphors doped with one or more rare earth elements are provided. These inventive methods are advantageous over previously known methods in that they enable modification of upconverting nanophosphors without particle agglomeration. Such methods comprise dispersing fluoride upconverting nanophosphors doped with rare earth elements in a non-polar solvent; forming a water-in-oil microemulsion comprising the upconverting nanophosphor dispersion, a surfactant, and a tetra-alkyl orthosilicate; hydrolyzing the tetra-alkyl orthosilicate to initiate growth of an SiO₂ layer on the nanophosphors; and destabilizing the microemulsion to precipitate upconverting nanophosphors coated with SiO₂ without forming SiO₂ particles or upconverting nanophosphor particle agglomerates. In addition, such methods may also include a step of coating the SiO₂-coated upconverting nanophosphors with a layer of an amino group-functional compound so that reactive amino groups are on the surface of the layer.

### BRIEF DESCRIPTION OF THE DRAWINGS

FIG. 1a: Presents a TEM image of Er³⁺ doped nanoparticles synthesized in TOPO at 340° C.

FIG. 1b: depicts a Histogram of the nanoparticles synthesized in TOPO.

FIG. 1c: Presents a TEM image of Er³⁺ doped nanoparticles synthesized in OM at 334° C.

FIG. 1d: Presents a TEM image of Er³⁺ doped nanoparticles synthesized in OA/ODE at 315° C.

FIG. 2: Presents an EDS analysis spectrum of the hexagonal (β-phase) nanoparticles synthesized in TOPO.

FIG. 3a: Presents XRD patterns of nanoparticles prepared with different solvents.

FIG. 3b: Presents XRD patterns of nanoparticles prepared with at different temperatures.

FIG. 4a: Presents TEM images of the nanoparticles prepared in TOPO at 360° C.

FIG. 4b: Presents TEM images of the nanoparticles prepared in TOPO at 360° C. The inset scale bar=5 nm.

FIG. 4c: Presents a selected-area electron diffraction pattern of the sample in FIG. 4a showing six of the diffraction rings corresponding to the hexagonal NaYF₄ lattice.

FIG. 5a: Presents TEM images of samples reacted at 380° C. for 30 min.

FIG. 5b: Presents TEM images of samples reacted at 380° C. for 50 min.

FIG. 5c: Presents TEM images of samples reacted at 380° C. for 70 min.

FIG. 5d: Presents TEM images of samples reacted at 380° C. for 90 min.

FIG. 6: Presents upconversion fluorescence spectra of Er³⁺ doped nanoparticles synthesized in different solvents.

FIG. 7a: Presents TEM images of NaYF₄:Yb,Ho

FIG. 7b: Presents TEM images of NaYF₄:Yb,Tm.

FIG. 7c: Presents Upconversion fluorescence spectra of NaYF₄:Yb, Ho and NaYF₄:Yb,Tm.

FIG. 8: Presents TEM images of NaYF₄:Yb, Er prepared in (a) OA/ODE, (b) OA/TOP/ODE, OA/TOP=4:1, (c) OA/TOP/ODE, OA/TOP=1:1, (d) OA/TOP/ODE, OA/TOP=1:4, and (e) TOP/ODE.

FIG. 9: Presents XRD patterns of the nanoparticles prepared in OA/TOP/ODE solvents at different OA/TOP ratios.

FIG. 10: Presents a schematic illustration of the phase transition due to the change of energy barrier via the oleate-TOP ligand formation for the synthesis of NaYF₄:Yb,Ln UCNP.

FIG. 11: Presents TEM images of the samples collected at 30 min of the reaction with (a) OA/TOP=1:1 and (b) OA/TOP=1:4.

FIG. 12: Presents TEM images (top) of the SiO₂ coated NaYF₄:Yb,Er UCNPs, (a) α-phase and b) β-phase, and their UC emission spectra (bottom) before and after coating. (c) presents comparison of UC emission spectra of the uncoated α-phase and β-phase nanoparticles.

FIG. 13a: Presents TEM images of OA/TOP coated nanoparticles.

FIG. 13b: Presents TEM images of SiO₂ coated UCNPs and SiO₂ particles.

FIG. 13c: Presents TEM images of clean SiO₂ coated nanoparticles.

FIG. 14a: Presents EDS results of UCNPs before SiO₂ coating.

FIG. 14b: Presents EDS results of UCNPs after SiO₂ coating.

FIG. 15: Presents upconversion emission spectra of the initial nanoparticles (a), and after coating amino (b) and carboxyl (c) groups.

### DETAILED DESCRIPTION

In one aspect, methods of preparing phosphorescent rare earth doped fluoride upconverting nanoparticles (UCNPs) are provided. Throughout the text, such nanoparticles may be interchangeably referred to as upconverting phosphorescent nanoparticles or upconverting nanophosphors (UCNPs) or nanocrystals (NCs). Employing various embodiments of the present invention produces monodisperse (non-aggregated), hexagonal phase fluoride nano-particles with a controllable size and morphology with a smooth surface and uniform distribution of rare earth dopant ions.

First, a precursor solution is prepared by dissolving one or more rare earth precursor compounds and one or more host metal fluoride compounds in a tri-substituted phosphine. The molar ratio of host metal fluoride compound to rare earth precursor compound is between about 95:5 and about 70:30, and preferably between about 90:10 and about 75:25. The stoichiometric amounts of host metal fluoride compound and rare earth precursor compound remain essentially the same, so that a 78:22 starting ratio of host compound to rare earth compound will result in a particle containing 22 mol % rare earth element ions.

The rare earth precursor compounds include, but are not limited to, organometallic rare earth complexes having the structure:

RE(X)₃

wherein RE is a rare earth element and X is an organic ligand. In the depicted formula, X is a monofunctional ligand. A single trifunctional organic ligand can be used, as well as a difunctional ligand in combination with a monofunctional ligand, in which case the depicted stoichiometry will be modified accordingly.

The term “rare earth” as used herein includes scandium, yttrium, and the fifteen lanthanoids. Strontium can also be used, and for purposes of the present invention, rare earth elements are defined as including strontium. Any rare earth element or combinations thereof can be used (i.e., europium, cerium, terbium, dysprosium, holmium, erbium, thulium, ytterbium, lutetium, etc.), with yttrium, holmium, ytterbium, erbium, thulium and mixtures thereof being preferred.

Suitable organic ligands include, but are not limited to, ligands such as trifluoroacetate, tetramethylheptanedionate, isopropoxide and the like. Trifluoroacetate (CF₃COO—) is a preferred organic ligand.

(CF₃COO)₃RE precursors are prepared by dissolving corresponding rare earth oxides in trifluororacetic acid and heating at reflux temperature. After clear solutions are obtained, the solvent is removed under vacuum and the resulting solids are dried.

The host metal fluoride compounds are selected so the resulting hosts are in the form of fluorides or oxyfluorides of the host metals. Suitable host metals include, but are not limited to, lanthanum, yttrium, lead, zinc, cadmium, sodium and any Group II metals such as, beryllium, magnesium, calcium, strontium, barium and any mixtures thereof.

The solvent used to prepare the precursor solution contains a tri-substituted phosphine or tri-substituted phosphine oxide. Tri-substituted phosphines and phosphine oxides suitable for use with the present invention remain liquid and do not decompose at a temperature less than about 400° C. Suitable compounds include, but are not limited to, trialkylphosphines and trialkylphosphine oxides such as trioctylphosphine oxide (TOPO), trioctylphosphine (TOP), tripropylphosphine, tripropylphosphine oxide, tri-n-butylphosphine, tri-n-butylphosphine oxide, tri-t-butylphosphine, tri-t-butyl-phosphine oxide, and the like. Tri-phenylphosphine and triphenyl-phosphine oxide can also be used, as well as phosphines and phosphine oxides with two or three different organic substituents, provided that the phosphines and phosphine oxides remain liquid and do not decompose at a temperature less than about 400° C. Phosphine mixtures that remain liquid and do not decompose at temperatures less than about 400° C. can also be used.

Trioctylphosphine oxide is employed in the preferred embodiments of the instant methods. In various embodiments, the solvent may consist essentially of a tri-substituted phosphine or phosphine oxide or include other solvents, such as oleic acid (OA), oleylamine, and noncoordination solvents, such as, octadence (ODE), therminol 66, and the like.

The exact content of the solvent may be varied depending on the desired size or shape of the resulting doped nanoparticles. By way of non-limiting example, using solvent consisting essentially of a tri-substituted phosphine oxide, preferably TOPO, may be used to produce doped nanoparticles in the range of about 5 nm to about 20 nm. On the other hand, using solvent consisting essentially of a mixture of tri-substituted phosphine, preferably TOP, and OA in a non-coordination solvent, such as, for example, ODE, may be used to generate doped nanoparticles in the range of about 20 nm to about 200 nm. Generally, the increase of TOP in the ratio of OA to TOP (OA/TOP) favors the transition of nanoparticles from α phase and β phase. Specifically, OA/TOP may range between about 1:1 to about 1:4, with the addition of OA/TOP in high and low ratio producing hexagonal particles and nanorods, respectively.

Next, the precursor solution is heated to facilitate formation of doped nanoparticles. First, the water may be removed from the solution by any known techniques, such as by heating the solution to 100° C. under vacuum for about 30 minutes. Second, nitrogen may be purged in the solution and the solution may be gradually heated to the targeted temperature. In the preferred embodiments, the targeted temperature is below the evaporation, boiling or decomposition temperature of the phosphine, more preferably between about 250° C. and about 400° C., and even more preferably between about 315° C. and about 370° C., and the solution is heated to the targeted temperature over a period of about 10 to about 15 minutes.

Finally, after allowing the reaction to proceed for a period of time, typically 15 minutes to three hours, the doped nanoparticles may be precipitated and isolated by any known method, typically by the addition of a quantity of polar solvent with cooling in an amount effective to render the particles insoluble in the resulting liquid. In some embodiments, the reactions may be allowed to proceed for about one hour, after which the solution may be allowed to cool and ethanol may be added to the cooled solution to precipitate the doped nanoparticles. The precipitated nanoparticles may be isolated from the solution by filtering, micro-filtering, centrifuging, ultracentrifuging, settling, decanting or a combination of these. Of course, a person having ordinary skill in the art will undoubtedly appreciate that the time periods as well as the precipitation and isolation techniques are provided only as an example, and such person will be capable of customizing them depending on the desired results, his or her own experience, and existing literature.

In another aspect, a method for surface modification of rare earth doped upconverting nanophospors (“UCNP”) is provided. Although UCNPs doped with rare earth elements have an excellent solubility in non-polar organic solvents, they need to be modified for potential biological applications to be hydrophilic. This can be achieved according to one embodiment of the present invention by coating surface of UCNPs doped with rare earth elements with a layer of silica.

UCNPs suitable for coating by this embodiment of the invention may be prepared by the low temperature precipitation methods disclosed herein, or by any methods known and used in the art for making rare earth doped fluoride nanoparticles. The particle size may be up to one micron. Suitable methods include, but are not limited to, co-thermolysis, thermal hydrolysis, laser heat evaporation, chemical vapor synthesis, microemulsion spray pyrolysis, and pool flame synthesis, and low temperature methods, such as sol-gel and homogenous precipitation.

The UCNPs are dispersed or dissolved with agitation in a non-polar solvent to form a non-polar phase. The concentration of UCPNs in the non-polar phase ranges between about 50 mg/mL and about 500 mg/mL and preferably between about 100 mg/mL and about 300 mg/ml. Suitable non-polar solvents include, but are not limited to, cyclohexane, toluene, hexane, pentane, isopentane, octane, heptane, and so forth, with cyclohexane being preferred.

Next, a water-in-oil microemulsion is formed by adding water and one or more surfactants to the non-polar phase with agitation, after which one or more tetra-alkyl orthosilicates are added to the UCNP microemulsion. The concentration of the surfactant in the surfactant solution is sufficient to form a stable microemulsion, and typically ranges between about 0.5 mL and about 10.0 mL per 100 mL of microemulsion and preferably between about 1.0 mL and about 2.0 mL per 100 mL of microemulsion. The surfactant may be an anionic, cationic, non-ionic or zwitterionic surfactant, and may be a monomeric or polymeric surfactant. One example of a suitable surfactant is NP-9 (nonylphenol ethoxylate), a nonionic polyethoxylated nonylphenol surfactant available from BASF, which may be employed by itself or in combination with one or more other surfactants.

The concentration of tetra-alkyl orthosilicate may be between about 0.05 mL and about 1.0 mL per 100 mL of microemulsion and preferably between about 0.1 mL and about 0.5 mL per 100 mL of microemulsion. Tetra-ethyl orthosilicate is a preferred tetra-alkyl orthosilicate, but others, including, but not limited to, tetra-methyl orthosilicate, tetra-propyl orthosilicate and tetra-butyl orthosilicate, may be used in addition to or instead of tetra-ethyl orthosilicate.

To initiate the formation of a layer of silicon dioxide (SiO₂) around the UCNPs, the tetra-alkyl orthosilicate is hydrolyzed. In some embodiments, the hydrolysis may be catalyzed by a Lewis base, such as dimethylamine (DMA). The Lewis Base is added in a quantity between about 0.025 mL and about 1.0 mL per 100 mL of microemulsion and preferably between about 0.05 mL and about 0.5 mL per 100 mL of microemulsion. The reaction is allowed to proceed for approximately 1 to 24 hours, after which the microemulsion may be destabilized to precipitate UCNPs coated with silicon dioxide. The thickness of the coating will depend upon the amount of tetra-alkyl orthosilicate and the amount of Lewis base added to the microemulsion.

The step of destabilizing the microemulsion may comprise adding to the suspension an effective amount of a polar solvent that is miscible with the non-polar solvent phase, the water phase, or both. Suitable examples include, but are not limited to, acetone, ethanol, methanol or some other liquid. The amount of polar solvent effective to destabilize the micoemulsion is used will vary depending on the surfactant and amount of surfactant used but is generally attained simply by using an excess quantity of material.

Alternatively or additionally, the step may also comprise changing the temperature, for example to a temperature at which the suspension is not stable. The particles precipitate, and may be separated from the destabilized microemulsion by filtering, micro-filtering, centrifuging, ultracentrifuging, settling, decanting or a combination of these. The precipitated UCNPs may be washed with a polar solvent to remove any physically adsorbed molecules from the surface of UCNPs.

The resulting silicon dioxide coated hydrophilic UCNPs are suitable for further biofunctionalization. Accordingly, the instant methods may further include a step of covalently attaching amino group-functional compounds to the silicon dioxide coated surface of the UCNPs. In some embodiments, such a step may comprise suspending SiO₂-coated UCNPs in a polar solvent, such as isopropanol, and adding an amino group-functional compound, such as alkylamine organosilane, such as 3-aminopropyltrimethoxy silane (APS), to the suspension. The concentration of SiO₂-coated UCNPs in the polar solvent may range between about 50 mg/mL and about 500 mg/mL and preferably between about 100 mg/mL and about 300 mg/ml.

In addition to amino groups, carboxyl groups may be coated onto UCPNs by directly mixing the UCNPs with amphiphilic modified polyacrylic acids (PAA) such as isopropyl amine and octylyamine modified PAA. The coatings of amino and carboxyl groups onto UCNPs' surfaces enable conjugation of nucleic acid sequences, as well as antibodies and other proteins and peptides, for biological applications such as bioassaying, bioimaging and photodynamic therapy.

### EXAMPLES

### Example 1

### Preparation of Nanoparticles in Trioctylphosphine Oxide Reagents

Trioctylphosphine oxide (TOPO) (90%), oleylamine (OM) (70%), octadecene (ODE) (90%), sodium trifluoroacetate (98%) and trifluoroacetic acid (CF₃COOH, reagent grade) were purchased from Sigma-Aldrich. Oleic acid (OA) was purchased from Fisher Scientific. 99.99% Ln₂O₃ (Ln=Y, Yb, Er, and Tm) were provided by Sunstone Inc. CF₃COOLn precursors were prepared by dissolving the corresponding lanthanide oxides in trifluoroacetic acid and heating at the reflux temperature. After clear solutions were obtained, the solvent was removed under vacuum. The resulting solids were dried under vacuum at room temperature overnight and used without further purification.

### Synthesis of NaYF₄:Yb, Ln (Ln=Er, Ho, and Tm) Upconverting NCs.

For the synthesis of hexagonal NaYF₄-doped with Yb, Ln (Ln=Er, Ho and Tm) upconversion nanocrystals (UPNCs or, simply NC), a mixture of 1.25 mmol CF₃COONa, 0.485 mmol (CF₃COO)₃Y, 0.25 mmol (CF₃COO)₃Yb, and 0.025 mmol (CF₃COO)₃Er (Ho,Tm) was dissolved in 10 g TOPO. Under vigorous stirring in a 50 ml flask, the mixture was first heated at 100° C. under vacuum for 30 min to remove water, and then nitrogen was purged into the solution periodically. In the presence of nitrogen, the solution was then heated to the targeted temperature within 10-15 min. All the reactions were stopped after one hour of heating at the desired temperature if not specified. Reactions were heated at reflux in OM (330-334° C.) and ODE/OA (315° C.). Ethanol was added to the cooled solution to precipitate the nanoparticles. The nanoparticles were isolated by centrifugation and were washed with ethanol at least three times.

### Characterization:

Powder x-ray diffractometer (XRD, 30 kV and 20 mA, Cu Kα, Rigaku) was used for crystal phase identification. The powders were pasted on an alumina substrate and the scan was performed in the 2θ range 10°-70°. The photoluminescence (PL) measurements were performed at room temperature. A 980 nm laser diode (1 W maximum, Lasermate Group, Inc.) was used as the excitation source and the beam was focused (12 cm focal length) to a spot size of approximately 0.5 mm. The PL signals were focused to the end of a optical fiber and then delivered into the slit of a monochromator (SP-2500i, Princeton Instruments) with a 2400 g mm⁻¹ grating (holographic, 400-700 nm). The signal was detected by a photomultiplier module (H6780-04, Hamamatsu Corp.) and was amplified by a lock-in amplifier (SR510, Stanford Research Systems) together with an optical chopper (SR540, Stanford Research Systems). The signal was recorded under computer control using the SpectraSense software data acquisition/analyzer system (Princeton Instruments).

Transmission electron microscope (TEM) and high-resolution TEM (HRTEM) images were obtained using a LEO/Zeiss 910 TEM equipped with a PGTIMIX EDX system (100 keV) and Philips CM200 FEGTEM equipped with a Gatan 678 Imaging Filter and a PGT-IMIX EDX system. With a field-emission-gun this microscope provides a point-to-point resolution of 0.2 nm and an electron probe of 0.7 nm with an energy up to 200 keV, respectively. The energy dispersive spectrometer (EDS) analysis was performed using a FEI XL30 FEG-SEM (scanning electron microscope) equipped with a PGT-IMIX PTS EDX system. The ¹H NMR spectrum was collected with Varian Inovas 500 MHz spectrometers.

### Results and Discussion:

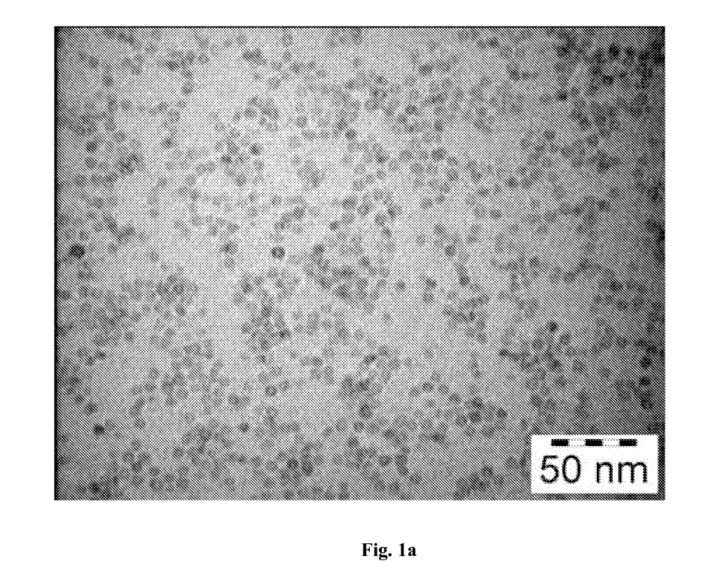

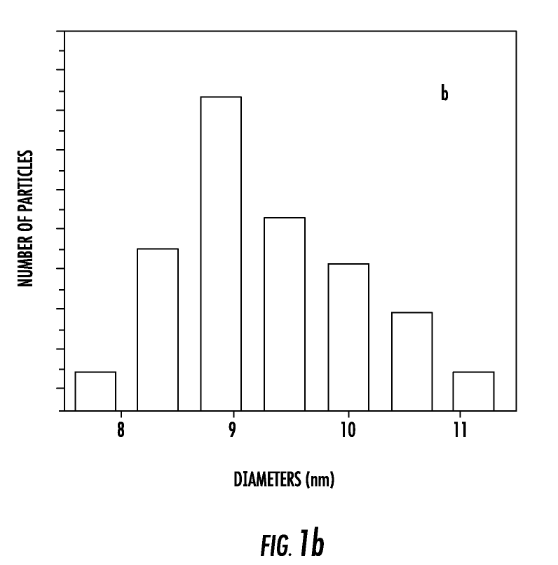

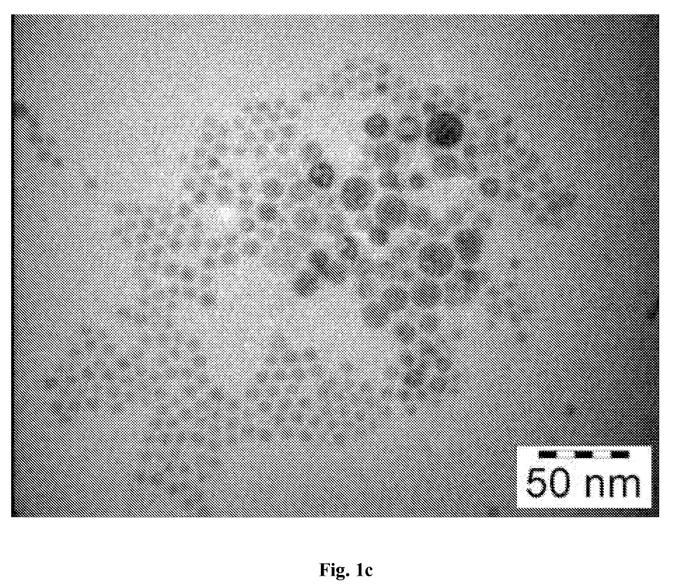

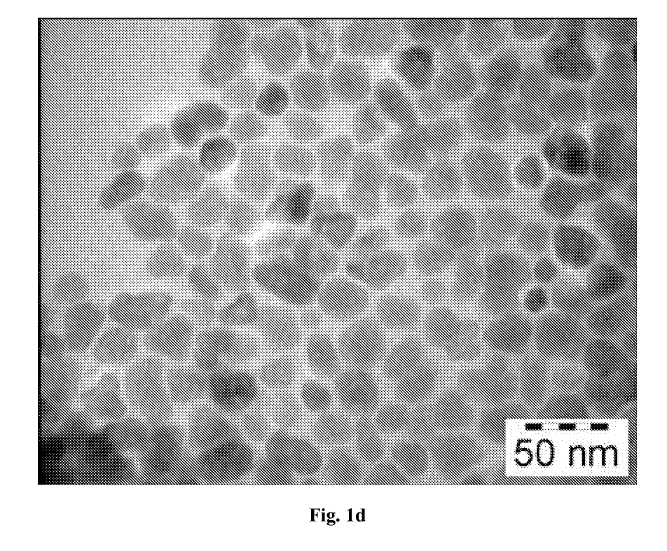

The molar ratios of the precursors CF₃COONa and (CF₃COO)₃Ln (Ln=Y, Yb and Er/Tm) were fixed at Na/Ln=1.6 for all the syntheses in TOPO, OM and OA/ODE solvents. The calculated compositions of the nanocrystals from the precursor concentrations were NaYF₄:Yb_{0.33}Er_{0.03}. TEM images of the NCs synthesized in different solvents are shown in FIGS. 1a-1d. These figures were generated based on 200 randomly selected particles.

From FIGS. 1a-1d, it can be seen that the NCs synthesized in TOPO (340° C.) had a very narrow size range from 7.8 to 11.1 nm with an average size of 9.2 nm and standard deviation (σ) of 0.73 (FIGS. 1a, b). The NCs synthesized in OM had a broad particle size distribution in the range from 7 to 20 nm with an average size of about 10 nm (FIG. 1c). As mentioned earlier, the broad particle distribution shown in FIG. 1c was the outcome of the aggregation process indicative of inefficient OM ligand protection. The OM heating (reflux) could also contribute to the reduced coordination properties of OM. The NCs synthesized in ODE/OA had the largest particle sizes (FIG. 1d), ranging from 15 to 40 nm with an average size of 25 nm, and they had irregular shapes. The TEM results indicate that the NCs prepared in TOPO have a highly monodisperse particle size distribution.

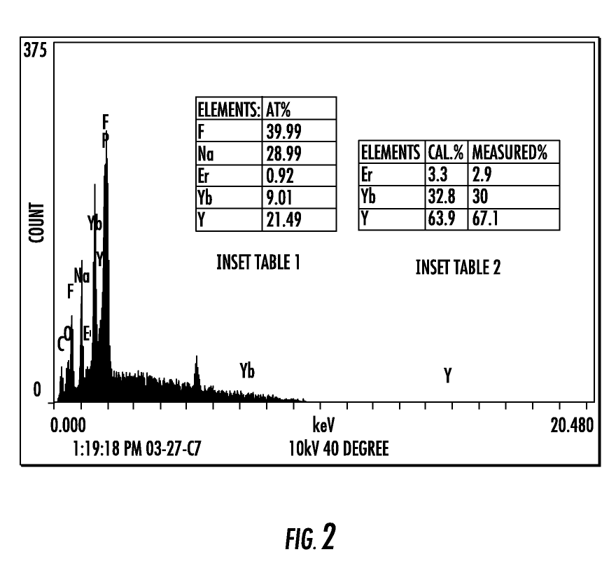

The atomic composition ratios of NCs synthesized in TOPO were determined by EDS analysis. FIG. 2 shows one EDS spectrum. Inset table 1 shows the measured atomic ratios of the elements, and inset table 2 shows the calculated and measured values of the lanthanides. The measured lanthanide atomic ratios and Na/Ln ratio (0.90) are very close to the calculated values. Since EDS is a semi-quantitative analysis method which is significantly affected by the surface properties of the sample, it is not a surprise that atomic % of fluoride is smaller than the calculated value. Thus, the x-ray diffraction (XRD) patterns of the α-phase and β-phase NaYF₄ crystals reported in standards and the literatures were compared with the crystalline structure of the NCs synthesized in this work.

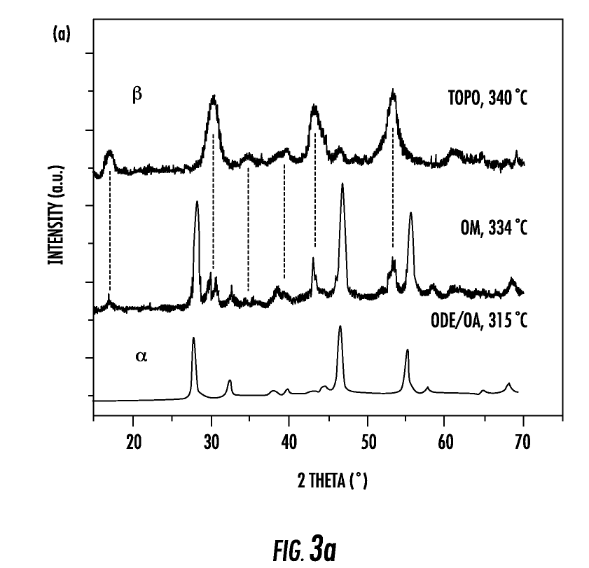

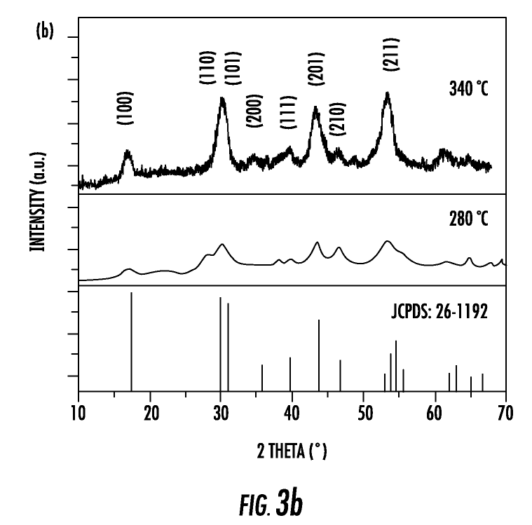

The XRD patterns of the corresponding NCs in FIGS. 1a-1d are shown in FIGS. a and b. The NCs prepared from ODE/OA presented pure α-phase, which agreed well with the literature results. The NCs prepared from OM (334° C.) exhibited mixed α- and β-phases, while the NCs prepared in TOPO, as shown in FIG. 3b, had diffraction peaks matching well with the β-phase NaYF₄ JCPDS data (card 28-1192); thus pure β-phase NCs resulted at 340° C. The peaks due to (110) and (100) reflections overlapped, which could be ascribed to the small NC particle size. The α→β phase transition in TOPO can be observed at a much lower synthesis temperature of 280° C. There is a small diffraction peak at 2θ=280 due to the α-phase in the diffraction curve for 280° C.

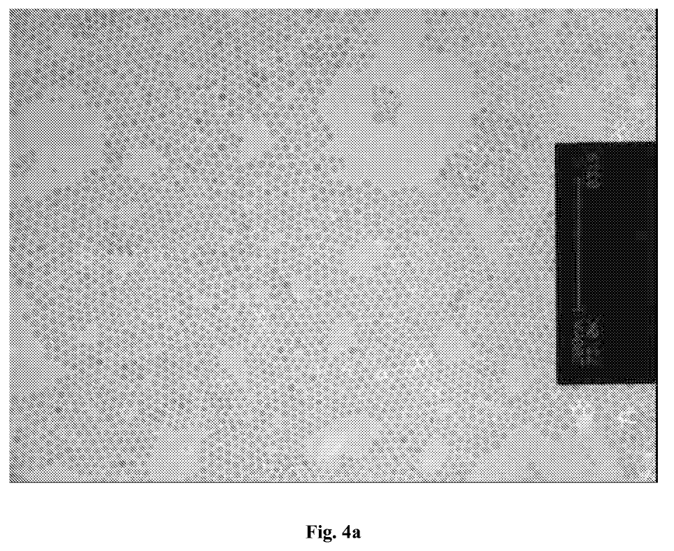

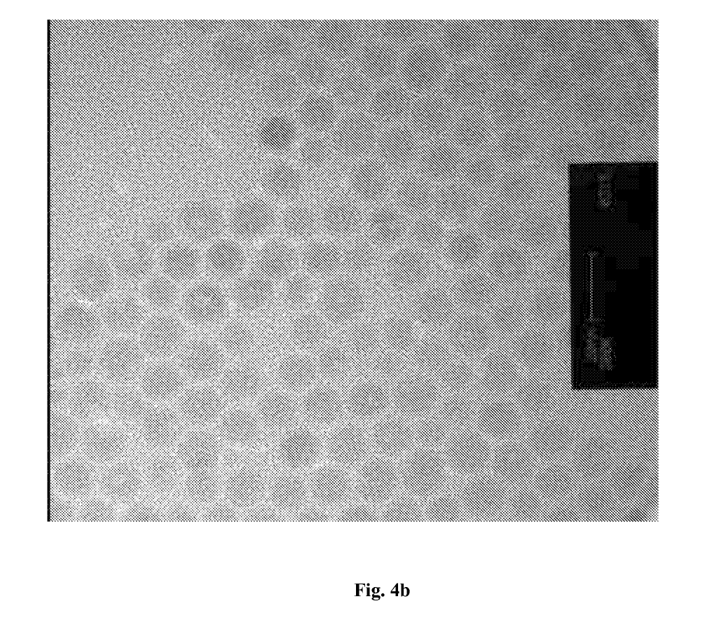

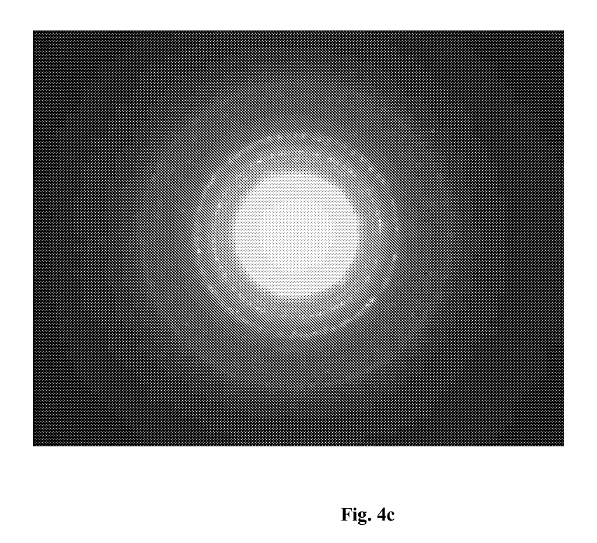

At 280° C., the NCs obtained in TOPO showed the dominant β-phase, while the NCs synthesized in OM and OA/ODE had dominant α-phase, which indicated that the energy barrier of the α→β phase transition was reduced significantly in TOPO compared with other available solvents/ligands, and led to the formation of the more efficient β-phase NCs and smaller NC particles. In contrast to the synthesis in OM and OA/ODE solvents, by using TOPO, the β-phase NCs were obtained in a much wider temperature window. The UCNPs can be prepared at an even higher temperature in this work. Another sample prepared at 360° c. is shown in FIGS. 4a-4c.

FIG. 4a shows the TEM image of the UCNPs synthesized at 360° C. The HRTEM image in FIG. 4b shows the crystalline fringes of the NCs. The selected-area electron diffraction (SAED) pattern, presented in FIG. 4c, shows spotty polycrystalline diffraction rings corresponding to the (100), (110), (111), (201), (311), and (321) planes of the β-phase NaYF₄ lattice. The high-limit temperature impact on NCs produced in TOPO solvent was investigated by increasing the reaction temperature to as high as 380° C. With the progress of heating the precursors in TOPO solvent, first the appearance of gas bubbles was observed at about 240° C., which indicated the decomposition of the metal trifluoroacetates; meanwhile, the solution turned from colorless into yellowish.

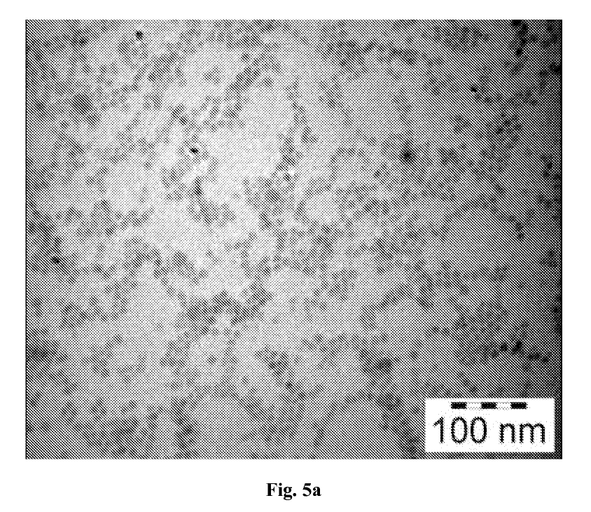

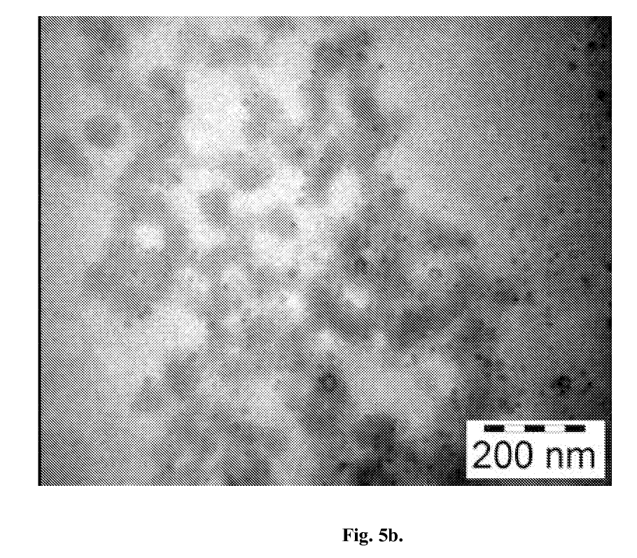

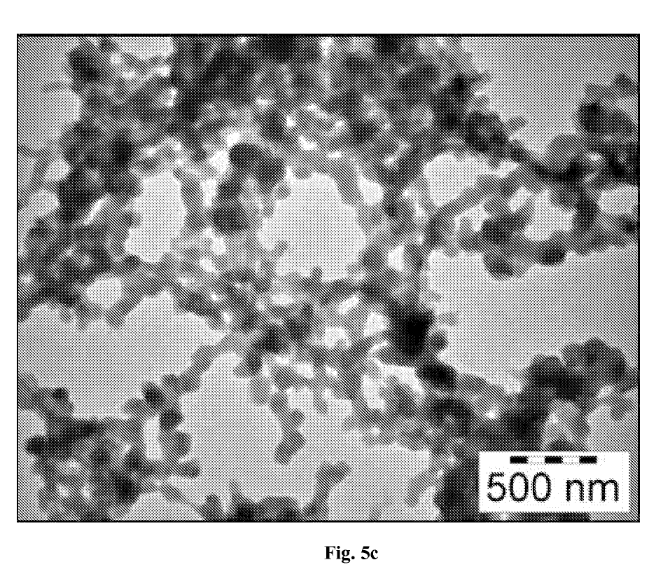

Above 240° C., the higher the solution temperature, the paler the solution color. After heating the solution to 360° C., second the evolution of light smoke appeared. When the solution temperature reached 380° C., there was a large amount of white smoke being produced vigorously and the solution color changed back to colorless very quickly. Therefore, the reaction was maintained at 380° C., and four samplings for the TEM measurements were collected at 30, 50, 70 and 90 min at this temperature. TEM images are shown in FIGS. 5a-5d.

As shown in FIG. 5a, the TEM image of the samples collected at 30 min still presented narrowly distributed particles with an average size of 11.1 nm. After reacting 20 more minutes, most of the independent NCs were disappearing and aggregating into bulky particles, as shown in FIG. 5b. At further extended reaction time, it is clearly seen that the particles are aggregating into larger chunks at 70 to 90 min, as shown in FIG. 5c and FIG. 5d, respectively. The samples collected at 90 min were then submitted to XRD and EDS measurements in which the XRD patterns showed no diffraction peaks (flat curves, spectrum not shown) and the EDS analysis showed irregular elemental ratios with F AT %<0.01%. The results indicated that the crystals lost their crystallinity during the aggregation process.

The breakdown of the crystals corresponded with the appearance of large amounts of smoke at the temperature of 380° C., which was most probably related to the decomposition of the TOPO solvent at elevated temperature. The role of TOPO was to provide surface binding and spatial restriction on the NCs to ensure monodispersed growth of the β-phase NCs. If the temperature was too high, the TOPO binding on the crystal surface was unstable due to TOPO decomposition. Therefore, TOPO lost its ligand property and the naked crystals further underwent aggregation in a similar way as in gas phase synthesis.

The results show that the NCs synthesized above 330° C. present the pure β-phase structure (one hour reaction), while the upper temperature limit of the synthesis in TOPO is 370° C. Comparing with the aggregation that appeared in OM solvent which happened at around 330° C., TOPO solvent provided much broader temperature windows for the synthesis of NaYF4-doped UP-NCs.

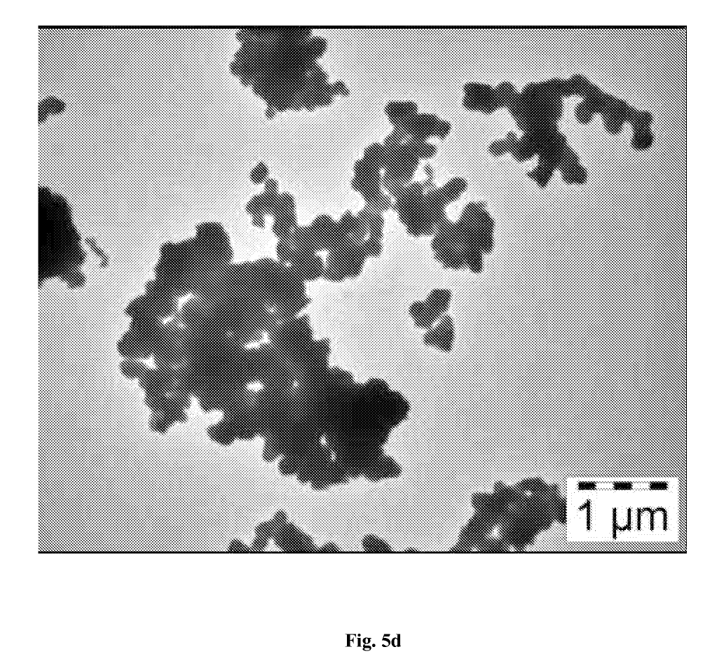

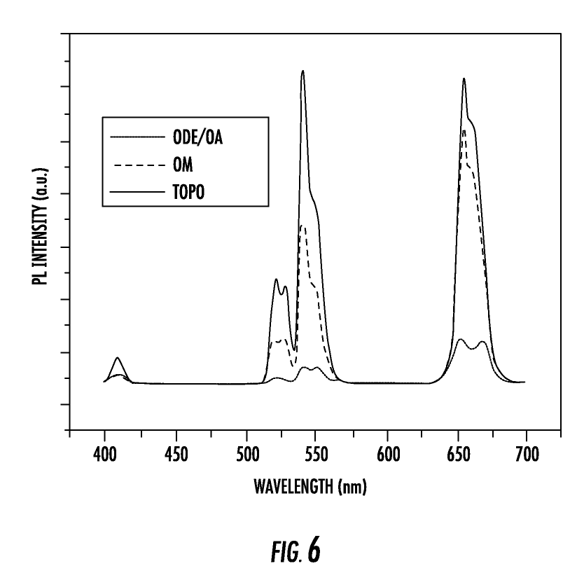

Fluorescence spectra of the three NCs are shown in FIG. 6. There were three emission peaks at 520.8, 545 and 658.8 nm, which were assigned to the ⁴H_{11/2} 4I_{(15/2)}, ⁴S_{3/2}-⁴I_{15/2} and ⁴F_{9/2}-⁴ I_{15/2} transitions for Er3+, respectively. The NCs prepared in TOPO present the brightest fluorescence compared with the NCs synthesized from ODE/OA and OM solvents. The NCs synthesized from TOPO show about 20 times higher emission intensity than those prepared from ODE/OA. Although the particle sizes of the NCs prepared from ODE/OA solvent are over 20 nm, they exhibit the weakest emission intensity due to the less efficient α-phase crystalline structure. This result further confirms that the β-phase NCs have much better fluorescent properties than the α-phase NCs.

On the other hand, the β-phase NCs synthesized from TOPO only show about two times higher emission intensity than the NCs synthesized from OM. Part of the reason is because there are large β-phase NCs (>20 nm) mixed in those NCs with a broad size distributed as shown in FIG. 1c. The upconversion fluorescence of lanthanide ion doped NCs is related to the particle size: generally, the larger the particle size, the higher the photoluminescence. The difference in the particle size distribution between the NCs synthesized from OM and TOPO can be further compared by the emission peak at the wavelength 658.8 nm. A sharp narrow emission peak is shown for the NCs synthesized from TOPO, while a broad shoulder for the NCs synthesized from OM is presented.

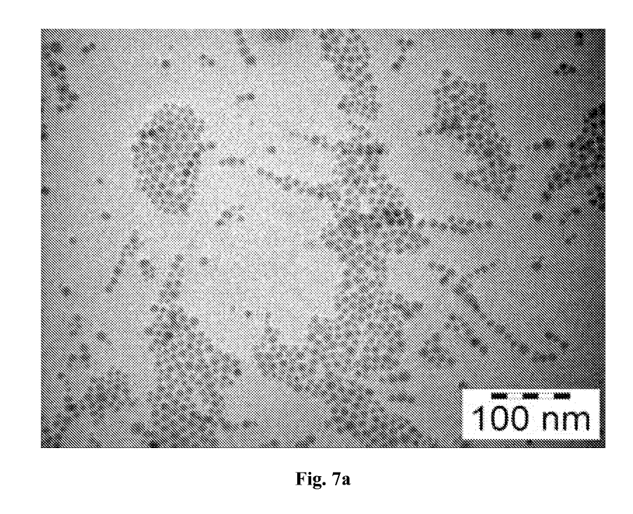

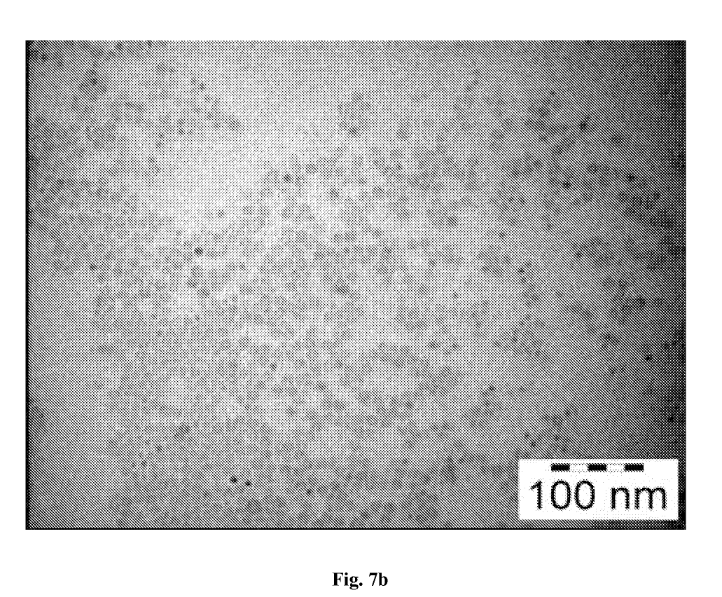

NCs of NaYF₄:Yb,Ho(Tm) were also prepared in TOPO. TEM images of Ho³⁺-doped and Tm³⁺-doped NCs are shown in FIGS. 7a and 7b, in which the average particle sizes are 11 and 10 nm, respectively. The UP fluorescence spectra excited at 980 nm are shown in FIG. 7c. Spectral bands corresponding to blue, green and red emission transitions of Ho³⁺ and Tm³⁺ are clearly depicted in the spectra. The mechanisms responsible for the UP fluorescence including those shown in FIGS. 7a-7c have been explained in detail in the literature. For the NCs doped with Ho³⁺, the emissions at 644.73 and 657.8 nm were assigned to the ⁵F₅-⁵I₈ transition, and the green emission at 542.4 nm corresponded to the ⁵S₂-⁵I₈ transition. For the Tm3+-doped NCs, the blue emission bands were assigned to the ¹D₂-³F₄, and ¹G₄-³H₆ transitions, while the red emission was assigned to the ¹G₄-³F₄ transition.

### EXAMPLE 2

### Particle Preparation in Oleic Acid OA and Trioctylphosphine (TOP) in (ODE)

### Particle Preparation:

The Na/Ln molar ratio was fixed at 1.6. Experiments were conducted for various OA/TOP/ODE solvents by varying the OA/TOP ratios. The particles were prepared by methods described above in Example 1. With the total solvent volume of 20 ml, the volumes of the OA/TOP/ODE solvents used for synthesis were (a) 10/10/0; (b) 8/2/10 (OA/TOP=4:1); (c) 2/2/16 (OA/TOP=1:1); (d) 2/8/10 (OA/TOP=1:4); and (e) 0/4/16. All reactions were stopped after 1 h heating between 315 and 320° C., unless specified otherwise. The size distribution and crystal structure of the as-synthesized particles were characterized by using the transmission electron microscopy TEM and x-ray diffraction XRD measurements.

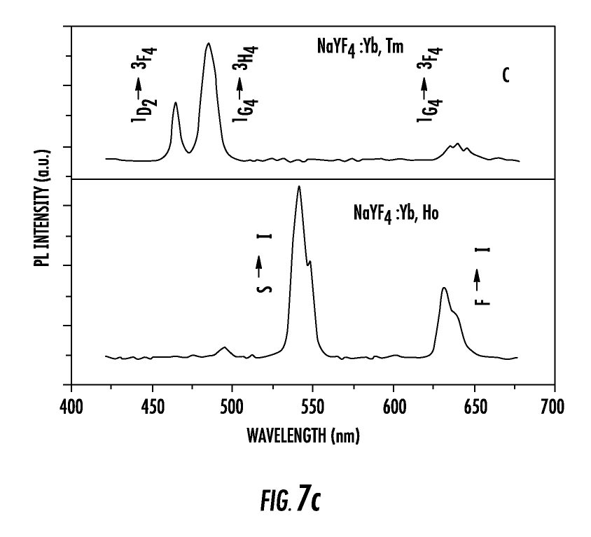

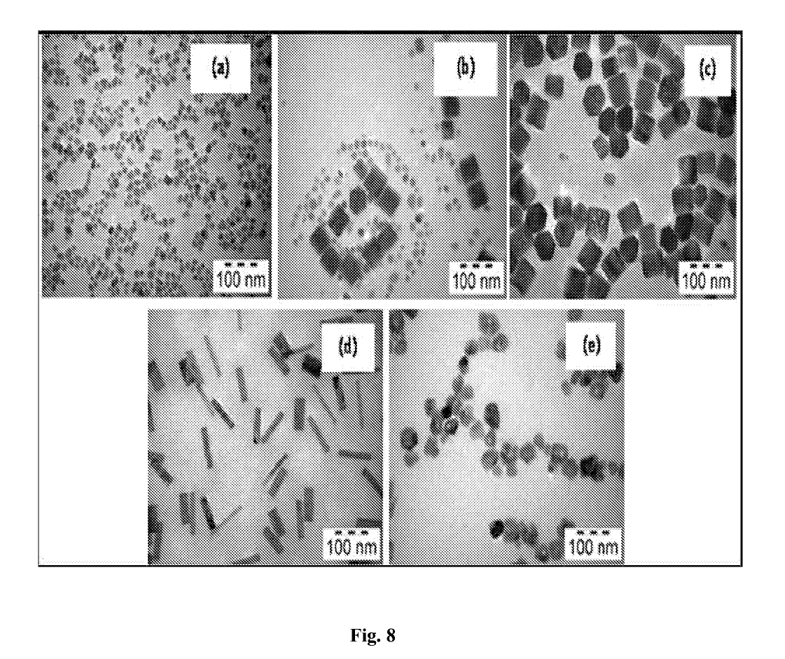

FIG. 8(a-e) shows the TEM images of the as-synthesized NaYF₄:Yb 33%, Er 3% UP-NCs at different OA/TOP ratios. The corresponding XRD patterns are shown in FIG. 9. The α-phase and β-phase crystalline structures were determined from NaYF4 JCPDS data for α-phase Ref. 29 and β-phase Ref. 30, and were also compared with the literature results.

### Results and Discussion:

The TEM images in FIG. 8(a-e) show that an α→β phase transition occurred with the increase of the TOP in OA/TOP ratios. The XRD patterns in FIG. 9 demonstrate that the crystal phase changed from pure α in OA/ODE to mixed phases and pure β in OA/TOP/ODE, and back to pure α in TOP/ODE. The results showing NCs synthesized in TOP/ODE solvents without OA remained in the phase α, as shown in FIG. 9 (graph (e)), excluded the possibility that the TOP ligand reduced the energy barrier for the α→β phase transition. The fact that the β-phase NCs were formed best and fastest in the OA/TOP ratio of unity suggested that the phase transition was most probably caused by a ligand formed between the OA and the Lewis base TOP, which produced totally different coordination properties to affect NC nucleation and growth. In order to understand the underlying mechanism, experiments of ¹H and ³¹P NMR spectra were conducted for the OA/TOP solvent mixtures before and after heating.

After heating, ¹H NMR results showed the disappearance of the protons from the carboxylic group, while ³¹P NMR presented the shifted phosphine peaks. Furthermore, ¹H NMR spectra analysis on NCs confirmed the coexistence of alkyl groups from oleate and TOP. All NMR analyses demonstrated that OA reacted with TOP at high temperature and formed a ligand with different coordination properties, leading to a reduced energy barrier for the phase transition. It is also interesting to note that at the OA/TOP ratio of 1:4, the α→β phase transition led to the formation of more dynamic stable rod-shape NCs, which indicated that the excess TOP ligand changed the NC surface energy of facets and caused anisotropic growth. A schematic mechanism for the phase transition due to the change of energy barrier via the oleate-TOP ligand formation is depicted in FIG. 10.

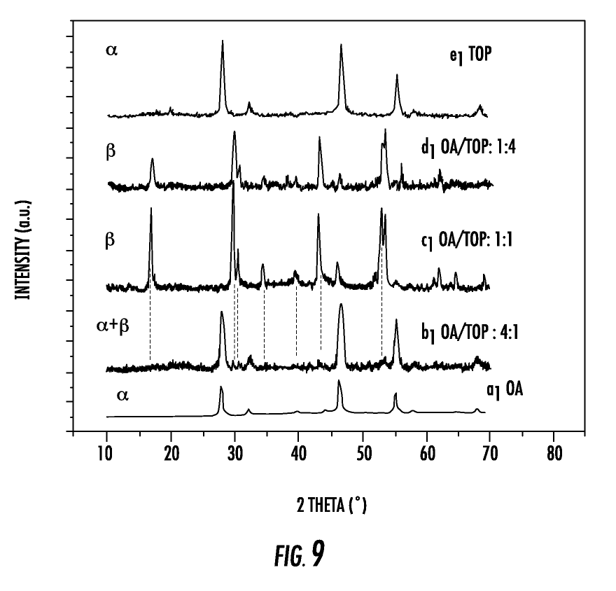

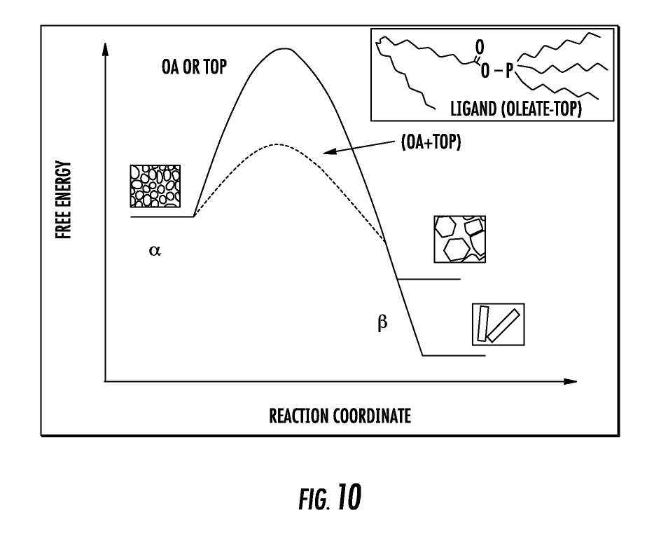

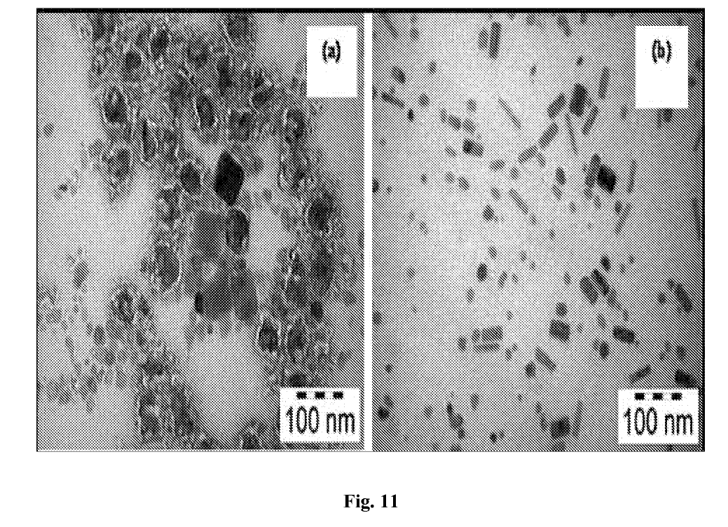

The coexistence of the small α-phase NCs with the large β-phase NCs in FIG. 8(b) indicates that the phase transition occurred at the same time as the Ostwald ripening. To confirm the occurrence of the Ostwald-ripening process, the samplings at the reaction time of 30 min were collected from solvents at OA/TOP ratios of 1:1 and 1:4. The corresponding TEM images of these samples are shown in FIGS. 11(a-b). In FIG. 11(a-b), it is seen that fewer large particles were formed by consuming many small ones, which is the typical Ostwald-ripening process for large particle growth. At the OA/TOP ratio of 1:1, the β-phase hexagonal nanoparticles were obtained in a broad range from 50 to 200 nm. A further increase of the TOP/OA ratio led to the formation of the rod-shape NCs. Therefore, an addition of TOP ligand into OA provided a different pathway other than changing precursor ratios to synthesize the β-phase NCs with tunable size and shape. NaYF₄:Yb,Tm and NaYF₄:Yb,Ho NCs were been prepared using the same method.

### EXAMPLE 3

### Coating Nanoparticles with Silicon Oxide Method

By using the method for silica coating onto oleate-capped PbSe quantum dots, a silica layer was coated onto the oleate and oleate/TOP capped α-phase and β-phase NCs produced in Example 2. See “Controlled Synthesis of Lanthanide-doped NaYF₄ Upconversion Nanocrystals via Ligand Induced Crystal Phase Transition and Silica Coating,” Appl. Phys. Lett., 91 (2007).

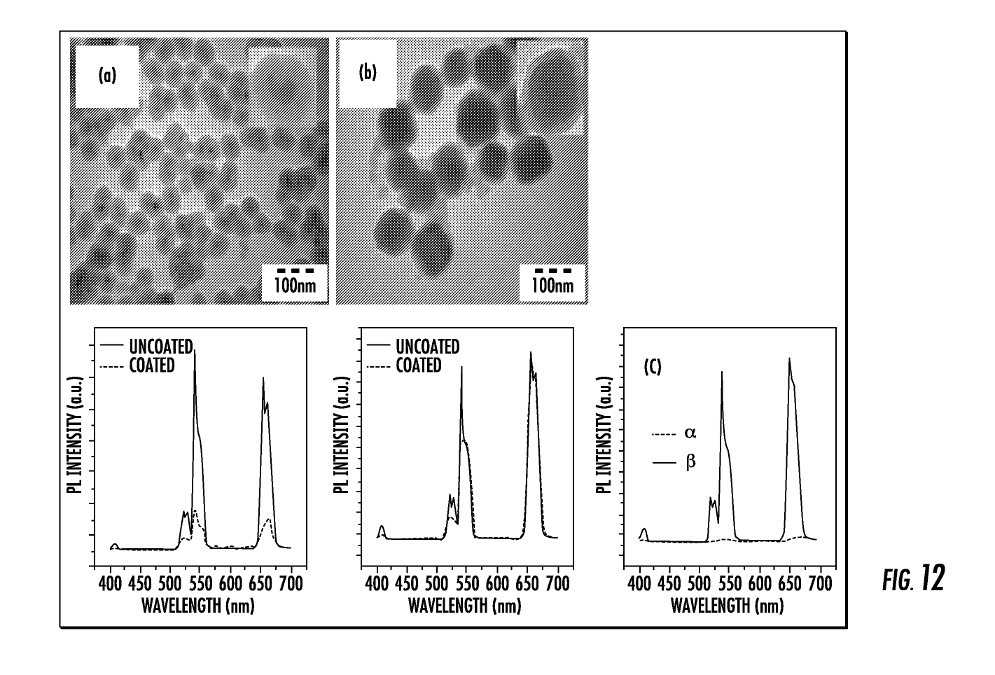

FIG. 12 shows the TEM images of the silica coated NCs: (a) the α-phase NaYF₄:Yb,Er synthesized in OA/ODE and (b) the β-phase NaYF₄:Yb,Er synthesized in OA/TOP/ODE solvents at unity OA/TOP ratio. Upconversion emission spectra of the corresponding NCs before and after coating is shown in FIG. 12(c). It is seen that for small NCs in the α-phase, silica coating leads to a dramatic reduction of luminescence intensity. However, for the β-phase NCs, silica coating almost does not affect the luminescence intensity and spectra, except in the green region.

The reason for the luminescence reduction for small NCs was evaluated by the volume ratio of the SiO2 coating layer to the particle. For samples in FIG. 12(a, b), the average thickness of the silica layers is 17 and 8 nm, respectively, and the approximate volume ratios between the coating layers and particles are 50 and 1.5, respectively. The much larger silica to crystal volume ratio in sample in FIG. 12(a) indicates that the ion density is decreased significantly when the outside coating thickness is comparable to the particle diameter, which results in the significant reduction of luminescence. For sample in FIG. 12(b), the small silica to crystal volume ratio causes less change in ion density, and thus the silica layer has less effect on luminescence intensity.

The emission peaks at 520.8, 545, and 658.8 nm of the Er doped NCs were due to ⁴H_{11/2} to ⁴I_{15/2}, ⁴S_{3/2} to ⁴I_{15/2}, and ⁴F_{9/2} to ⁴I_{15/2} transitions for Er³⁺, respectively. However, it is interesting to note that for β-phase NCs of sample in FIG. 5(b), the luminescence intensity of green emission was reduced more significantly than that of red emission before and after the silica coating. The reason is because the green emission is a three-photon process which is more sensitive to the reduction of the excitation intensity than the two-photon red emission. The emission intensities for green and red emissions are, respectively, proportional to the cubic and square of the excitation intensity.

In addition, the quantum efficiency of UC-NCs strongly depends on the particle crystal size. Large particles will deliver stronger luminescence. To demonstrate the improvement of luminescence intensity via phase transition, the UC emission spectra of the uncoated α-phase and β-phase NCs are compared in FIG. 12(c). It is clearly seen that the large β-phase NCs have much stronger emission intensity than that of the α-phase NCs. After coating with silica, both α-phase and β-phase NCs could be suspended in polar solvents such as ethanol for a very long time, which would be suitable for further biofunctionalization.

### EXAMPLE 4

### Coating Nanoparticles with Silicon Oxide and Amino-Functional Group Compounds

### Materials and Methods: Biofunctionalization.

The silica coated upconverting nanophospors (UCNPs) were prepared based on the method developed by Darbandi et al., “Silica encapsulation of hydrophobically ligated PbSe nanocrystals,” Langmuir, 22, 4371-5, (2006) with two modifications. First NP-9 was used instead as the surfactant of NP-5 and secondly, due to the low solubility of UCNPs in cyclohexane, there was no stock solution being prepared, while a long sonification time was needed to disperse the UCNPs before the silica coating.

Typically, 40-50 mg OA-TOP capped UCNPs were dissolved in 100 mL cyclohexane by sonicating 30 min, then 2 mL NP-9 and 0.1 mL TEOS were added which were followed by vigorous stirring for 30 min to form water-in-oil (W/O) microemulsion system. 50-100 μL DMA was then added to initiate hydrodrolysis of TEOS to form an SiO₂ layer onto the UCNPs. The SiO₂ growth was stopped after 12-24 hours reaction. The nanoparticles were destabilized from the micro-emulsion using ethanol and precipitated by centrifugation.

The resulting UCNP/SiO₂ composite particles were washed with absolute ethanol three times. For each washing step, followed by centrifugation, a sonicator bath was used to completely disperse the precipitate in the ethanol and remove any physically adsorbed molecules from the particle surfaces. Finally, UCNP/SiO₂ nano-particles, which were dispersable in ethanol and water, were obtained. To add amino functional groups, 10 mg UCNP/SiO₂ were resuspended in 50 mL isopropanol by sonication. 0.1-0.4 mL APS was then added dropwise under vigorous stirring, which was allowed to react at room temperature for 12 hours. Then, the amino coated UCNPs nanoparticles were collected by centrifugation and washed three times in pH=7.4 phosphate buffer. Quantification of amino concentration on UCNPs was made by using nihydrin test.

Carboxyl coated UCNPs were obtained by mixing as-synthesized UCNPs with octylamine and isopropylamine modified PAA directly. The modified PAA was prepared in a similar way to that in Gohon et al., “Partial specific volume and solvent interactions of amphipol A8-35,” Anal. Biochem., 334, 318-34 (2004).

Cell uptake experiments were performed by incubating UCNPs with human osteosarcoma cells (HOS; ATCC, Manassas, Va.). The HOS cells were cultured in 25 cm² flasks (Becton-Dickinson, Franklin Lakes, N.J.) and maintained in an incubator at an incubation temperature of 37° C. regulated with 5% CO₂, 95% air, and saturated humidity. A Dulbecco's Modified Eagle Medium (DMEM) supplemented with 10% fetal bovine serum and 1% penicillin/streptomycin/amphotericin B was used as the cell culture medium (Quality Biological, Gathersburg, Md.). At confluence, the cells were sub-cultured by splitting. A cell suspension at a concentration of approximately 5×10⁴ cells/ml was then prepared, as determined by a hemocytometer count. The cells were seeded into the 24-well culture plate, 10⁴ cells (200 μL×5×10⁴ cells/ml) in each well. Then, 50 μL of UCNP solution was added to each of 3 wells and kept at 37° C. in a fully humidified atmosphere at 5% CO₂ in air.

After incubation, the cells were grown as a monolayer and fixed for 2.5 hr with 2% glutaraldehyde in 0.2 M sodium cacodylate buffer, pH 7.2, rinsed with 0.2 M sodium cacodylate buffer, pH 7.2, post-fixed with 1% OsO₄ in sodium veronal buffer, for one hour at about 4° C., rinsed with sodium veronal buffer. Incubated with 0.25% toluidine blue for 60 min in 0.2 M sodium cacodylate Buffer, pH 7.2, rinsed with 0.2 M sodium cacodylate buffer, pH 7.2, rinsed with 0.05 M sodium maleate buffer, pH 5.1, incubated overnight with 2% uranyl acetate in 0.05M sodium maleate buffer in the dark. Samples were rinsed with 0.05 M sodium maleate buffer, ethyl alcohol dehydrations, and then into a 1:1 dilution of EtOH:Resin, 1:2 EtOH:Resin (standard Epon Resin recipe) for 2-3 hrs each, then into straight resin overnight. Unstained 70 nm sections were obtained using a diamond knife on a Leica UC6 Ultramicrotome and observed at 80 kV on a Zeiss 912AB Transmission Electron Microscope equipped with an Omega Energy Filter. Micrographs were captured using a digital camera from Advanced Microscopy Techniques and saved as tiff files onto a Dell PC computer.

### Results and Discussions:

In this method, reversed micelles were formed by water nano-droplets in an organic medium and further used for synthesis or surface modification of nanoparticles. The formation of SiO₂ starts from the hydrolysis of TEOS at the oil/water interface catalyzed by bases such as dimethylamine (DMA). Comparing with oleate and TOPO coated quantum dots, the hexagonal phase UCNPs usually have larger particle sizes (˜100 nm) and less solubility in organic solvent. For example, OA/TOP capped UCNPs can be dissolved in hexane to form a stable solution, but the solution is not transparent.

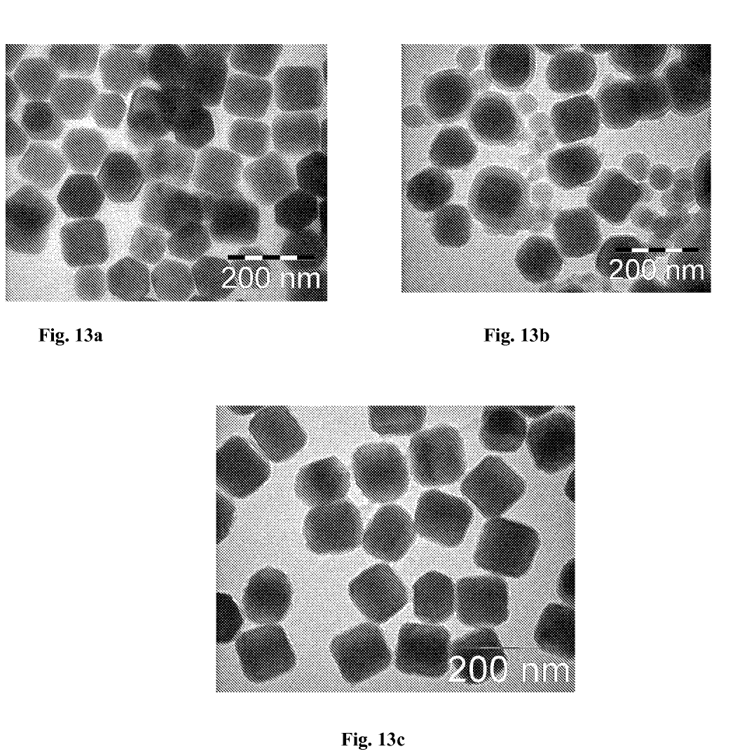

FIGS. 13a-13c depict TEM images of as-synthesized UCNPs and products of SiO₂ encapsulation in the presence of DMA as catalyst for TEOS polymerization. To investigate the conditions of forming the SiO₂ layer we started by adjusting UCNP and DMA concentrations. In the first two comparison experiments, the same amounts of original UCNPs, NP-5, DMA and TEOS were used with 40 mg, 2 mL, 100 μL, and 0.12 mL, respectively. However, the amounts of solvent and cyclohexane were 25 mL and 50 mL, respectively. Under the same reaction time of 24 hours reaction of the mono-disperse UCNPs (FIG. 1a) with TEOS in 25 mL solvent resulted in agglomerated SiO₂ particles (FIG. 1b) and the average SiO₂ layer thickness on the UCNP surface was 12 nm. However, the reaction in 50 mL cyclohexane led to clean SiO₂ coated UCNPs. Neither independent SiO₂ particles nor particle agglomeration were observed. The average coating layer thickness is 8 nm.

To examine the sensitivity of DMA concentration the same reaction with 25 mL cyclohexane was also performed but using 0.06 mL DMA. Clean UCNP/SiO₂ particles were also obtained. The results above indicate if the concentrations of the DMA were adequately adjusted, the formation of SiO₂ particles and particle agglomeration could be avoided in silica coating for UCNPs.

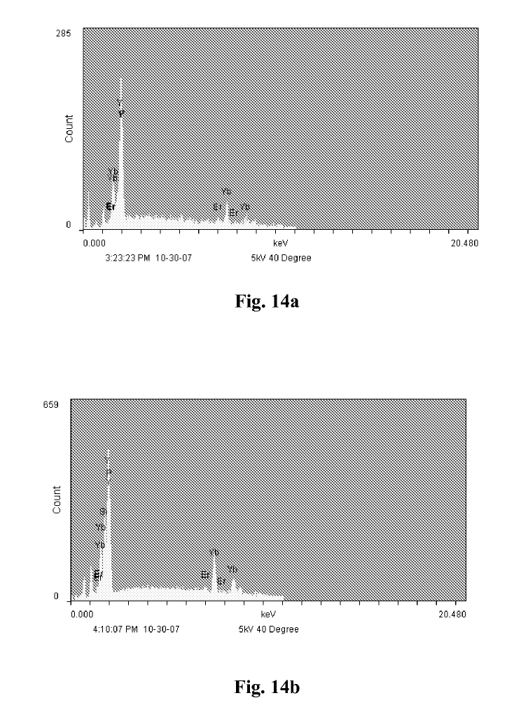

The P/Y atomic ratios of the samples were measured before and after SiO₂ coating by EDS. The EDS results are shown in FIGS. 14a and 14b. FIGS. 14a and 14b present the EDS results of the samples in FIG. 1(a, c) in which both samples show strong P intensity. Calculation shows that P/Y ratios are 0.082 and 0.083 before and after SiO₂ coating, respectively. While additional EDS measurements of the sample in FIG. 13b in which there were many independent SiO₂ particles showed P/Y ratio of 0.080. The results demonstrate that there was no ligand exchange undergoing during SiO₂ growth onto hydrophobically ligated UCNPs. Our results showed that OA-TOP ligands were encapsulated inside SiO₂ layer.

After introducing the bio-compatibility by coating SiO₂ layer onto the hydrophobic UCNPs, amino functionalization was performed by reacting UCNP/SiO₂ with APS. In addition to amino groups, we developed an alternative method by directly adding carboxyl groups onto UCNPs. The carboxyl group functionalization was achieved by mixing amphiphilic modified PAA with the hydrophobically ligated NCs. After the addition of carboxyl groups with amphiphilic PAA coating, it was confirmed that the hydrophobic UCNPs becomes disperable in water.

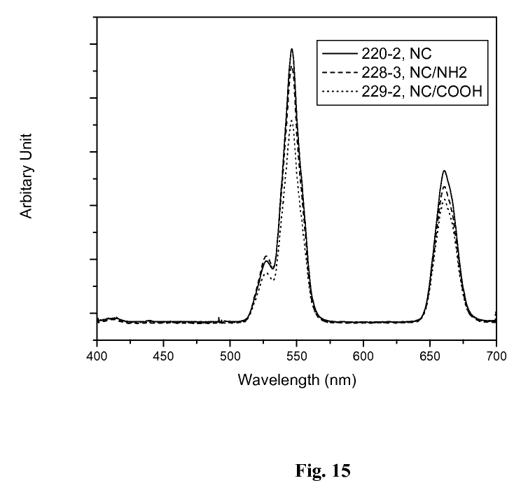

After the coatings of amino and carboxyl groups, the impact of surface functionalization on the UCNP upconverison luminescence intensity was investigated. FIG. 15 shows the comparisons of the emission spectra of the UCNPss before and after coating the amino and carboxyl groups with a NIR excitation at 980 nm. Our results showed that both amino/SiO₂ coatings and the direct carboxyl coating have very little effect on the emission intensity. The coatings of amino and carboxyl groups onto UCNP surface enable specific antibodies conjugation for biological applications. The little change of luminescence intensity is a promising result for the application of UCNPs for bioimaging and photodynamic therapy.

For biomedical applications, the data of cytotoxicity and the ability of biocompatibility of the functionalized UCNPs are the two important factors and need to be obtained. In this study, the cell toxicity and the cell uptake were investigated by incubating the above functionalized UCNPs with human osteosarcoma cells. The toxicity and the cell uptake results are shown in FIG. 5 and FIG. 6, respectively.

The foregoing examples and description of the preferred embodiments should be taken as illustrating, rather than as limiting the present invention as defined by the claims. The scope of the invention is therefore defined in the claims which follow. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the claims.

What is claimed is:

1. A method of preparing rare earth doped monodisperse, hexagonal phase upconverting nanophosphors, said method comprising:
dissolving one or more rare earth precursor compounds and one or more host metal fluoride compounds in a solvent comprising a tri-substituted phosphine or a tri-substituted phosphine oxide to form a solution;
heating the solution to a temperature above about 250° C. at which the phosphine or phosphine oxide remains liquid and does not decompose; and
precipitating and isolating from the solution phosphorescent hexagonal phase monodisperse nano-particles of the host metal compound doped with one or more rare earth elements.

2. The method of claim 1, wherein said rare earth precursor compound is an organometallic lanthanide complex having the structure:
RE(X)₃
wherein RE is a rare earth element and X is an organic ligand.

3. The method of claim 2, wherein X is a trifluoroacetate ligand.

4. The method of claim 1, wherein said rare earth element is selected from the group consisting of holmium, ytterbium, erbium, thulium, and mixtures thereof.

5. The method of claim 1, wherein said host metal is selected from the group consisting of lanthanum, yttrium, lead, zinc, cadmium, sodium, beryllium, magnesium, calcium, strontium, barium and any mixtures thereof

6. The method of claim 1, wherein said precipitated nanoparticle host metal compound is a fluoride or oxyfluoride.

7. The method of claim 1, wherein said solvent comprises a tri-substituted phosphine selected from the group consisting of trioctylphosphine, tripropylphosphine, tri-t-butylphosphine, tri-phenylphosphine, tri-n-butylphoshine and mixtures thereof.

8. The method of claim 1, wherein said solvent comprises a tri-substituted phosphine oxide selected from the group consisting of trioctylphosphine oxide, tripropylphosphine oxide, tri-t-butylphosphine oxide, triphenylphosphine oxide, tri-n-butylphoshine oxide and mixtures thereof.

9. The method of claim 1, wherein the solution is heated to between about 250° C. and about 400° C.

10. The method of claim 8, wherein said solvent consists essentially of trioctylphosphine oxide.

11. The method of claim 10, wherein said nanophosphors have a monodisperse particle size between about 5 and about 20 nm.

12. The method of claim 1, wherein said nanophosphors comprise NaYF₄:Yb,Ln, wherein Ln is selected from the group consisting of Er, Ho and Tm.

13. The method of claim 1 further comprising the step of coating the surface of said nanophosphors with a carboxylic acid compound.

14. The method of claim 13, wherein said carboxylic acid compound is a modified amphiphilic polyacrylic acid.

15. The method of claim 1, further comprising the step of coating the surface of said nanophosphors with an SiO₂ layer.

16. The method of claim 15, further comprising the step of covalently bonding to said SiO₂ layer of said nanophosphors, a layer of a compound comprising reactive amino groups that remain exposed on said layer for further reaction.

17. The method of claim 16, further comprising the step of covalently attaching a nucleotide sequence, antibody or other protein or peptide to one of said reactive amino groups.

18. A method for coating upconverting nanophosphors doped with one or more rare earth elements, said method comprising:
dispersing upconverting nanophosphors (UCNPs) doped with rare earth elements in a non-polar solvent;
forming a water-in-oil microemulsion comprising the UCNP dispersion, a surfactant, water and a tetra-alkyl orthosilicate;
hydrolyzing said tetra-alkyl orthosilicate to initiate growth of an SiO₂ layer on said nanophosphors; and
destabilizing said microemulsion to precipitate UCNPs coated with SiO₂ without forming SiO₂ particles or nanophosphor agglomerates.

19. The method of claim 18, wherein said microemulsion is destabilized by adding an effective quantity of a polar solvent.

20. The method of claim 1, wherein said tetra-alkyl orthosilicate is tetra-ethyl orthosilicate.

21. The method of claim 18, wherein said surfactant is a non-ionic nonylphenol ethoxylate.

22. The method of claim 18 further comprising the step of covalently attaching to said SiO₂-coated UCNPs a layer of a compound comprising reactive amino groups that remain exposed on said layer for further reaction.

23. The method of claim 22, wherein said compound comprising reactive amino groups is an alkylamine organosilane compound.

24. The method of claim 23, wherein said alkylamine orgranosilane comprises 3-aminopropyltrimethoxy silane (APS).

25. The method of claim 18, wherein said tetra-alkyl orthosilicate is hydrolyzed by adding an organic Lewis base.

26. The method of claim 18, wherein said organic Lewis base is dimethyl amine (DMA).

27. Hexagonal phase mono-disperse fluoride or oxyfluoride nanophosphors of a host metal compound doped with one or more rare earth elements prepared by the method of claim 1.

28. Hexagonal phase mono-disperse fluoride or oxyfluoride nanophosphors particles of a host metal compound doped with one or more rare earth elements.

29. The nanophosphors particles of claim 28, wherein said host metal is selected from the group consisting of lanthanum, yttrium, lead, zinc, cadmium, sodium, beryllium, magnesium, calcium, strontium, barium and any mixtures thereof.

30. The nanophosphors particles of claim 28, wherein said rare earth element is selected from the group consisting of holmium, ytterbium, erbium, thulium, and mixtures thereof.

31. The nanophosphors particles of claim 28, wherein the surface of said nanophosphors are coated with an SiO₂ layer.

32. The nanophosphors particles of claim 31, wherein an alkylamine organosilane compound is covalently bonding to said SiO₂ layer of said nanophosphors

33. The nanophosphors particles of claim 28 consisting essentially of particles having a monodisperse particle size less than about 20 nm.

34. The nanophosphors particles of claim 33, wherein said monodisperse particle size is between about 5 and about 15 nanometers.

35. The nanophosphors particles of claim 28, having a quenching limit concentration above about 10 mol %.

36. The nanophosphor particles of claim 35, wherein said particles comprise up to about 30 mol % of said rare earth element and are essentially free of quantum quenching effects.
